(19) United States
(12) Patent Application Publication
(10) Pub. No.: US 2006/0138763 A1
(43) Pub. Date: Jun. 29, 2006

(54) Airbag and sensor-equipped roll bar for open vehicles

(76) Inventor: Robert J. Brady, Fort Lauderdale, FL (US)

Correspondence Address: Donald W. Meeker;Patent Agent, 924 East Ocean Front #E, Newport Beach, CA, 92661, US

(21) Appl. No.: 11/026,823

(22) Filed: Dec. 29, 2004

(51) Int. Cl. B60R 21/13

(52) U.S. Cl. 280/756

(57) ABSTRACT

A vehicle safety device for open top, convertible or soft-topped vehicles that has a roll bar that is welded to an existing vehicle with sensors that trigger the deployment of airbags in an event of a vehicle roll-over to cover the top and the sides of the driver and passenger compartment.

### BACKGROUND OF THE INVENTION

1. Field of the Invention

The present invention relates to vehicle safety devices and particularly to a roll bar for open top, convertible or soft-topped vehicles equipped with rollover sensors that trigger the deployment of airbags located on the roll bar, which protect the occupant of the vehicle from the sides and above.

2. Description of the Prior Art

Inflatable safety restraint devices, or airbags, are now a legal requirement for many new vehicles. Airbags are typically installed in the steering wheel and in the dashboard on the passenger side of a car. Additionally, airbags may be installed to inflate beside the passenger to provide side impact protection, in front of the knees to protect the knees from impact, over a passenger's head, or at other strategic locations.

In the event of an accident, an accelerometer within the vehicle measures the abnormal deceleration and triggers the ignition of a pyrotechnic charge. Expanding gases from the charge fill the airbags, which immediately inflate to protect the driver and/or passengers from impact against the interior surfaces of the vehicle. During normal vehicle operation, airbags are typically stowed behind covers to protect them from tampering and provide a more attractive interior facade for the vehicle.

Many devices have been provided having a rollover sensor, which may be adapted to measure the orientation of the vehicle or the angular speed of the vehicle to activate a mechanism, which moves a roll bar into a protecting position, or to activate pre-tensioners (which pre-tension safety belts) or air bags, when a rollover accident occurs.

The prior art lacks effective top and side airbag protection for open top vehicles.

U.S. Pat. No. 5,775,726, issued Jul. 7, 1998 to Timothy, shows a roof-mounted air bag. A passive vehicle occupant restraint system is provided for an automotive vehicle having a front seat including a seat back defining generally a front passenger area to one side thereof and a rear passenger area to the other side thereof, and a roof having an outer roof surface, a quantity of insulation material inside of the outer roof surface and a headliner beneath and overlying the insulation material. The restraint system includes a first inflatable cushion mounted between the insulation material and the headliner and overlying at least a portion of the front passenger area of the vehicle, and an inflator operatively connected with the inflatable cushion and responsive to a predetermined triggering signal for producing a quantity of inflating gas for inflating the cushion.

U.S. Pat. No. 5,641,193, issued Jun. 24, 1997 to Zepnik, provides a convertible passenger car with a top and a rollover protection arrangement. The rollover protection device and the top are combined to form a pre-assembled constructional unit produced outside the vehicle. A side air bag may also be fastened on the forward supporting section of the rollover bar.

U.S. Pat. No. 6,457,740, issued Oct. 1, 2002 to Vaidyaraman, discloses an apparatus for helping to protect an occupant of a vehicle having a roof and a side structure, which includes an inflatable device having a deflated condition and having an inflated condition. In the inflated condition, a head portion of the inflatable device is inflated between the occupant's head and the vehicle roof and a side portion of the inflatable device is inflated between the occupant and the vehicle side structure. The apparatus further includes an actuatable inflation fluid source for upon actuation directing inflation fluid into the inflatable device to inflate the inflatable device from the deflated condition to the inflated condition. The head portion of the inflatable device is inflated by inflation fluid flow in a direction transverse to the vehicle side structure. In a preferred embodiment, the head portion of the inflatable device when in the deflated condition has panels which lie generally parallel to a headliner between the headliner and the roof and which extend from the vehicle side approximately to the vehicle centerline.

U.S. Pat. No. 5,743,561, issued Apr. 28, 1998 to Kim, is for a roll-bar structure for a conventional motorcycle configured to provide both forward and aft ward protection as well as side protection. The basic embodiment comprises dual spaced apart longitudinal tubular, metal members of inverted U-shaped design, the lower terminuses of which are oppositely fixed to both the front and rear of the motorcycle mainframe. Other embodiments include an articulated rear-half assembly which can move fore and aft according to the position of the motorcyclist, a longitudinal roll-bar configuration appearing substantially H-shaped in side view, and a combination of an inverted U-shaped roll-bar and an H-shaped roll-bar. A personal restraint system such as seat belt or lap belt, shoulder belt, netting, or airbag system, is mounted or secured on to the front-to-back roll bars to cushion the operator and to prevent the operator from being thrown off the motorcycle in the event of a collision.

U.S. Patent Application #20040090050, published May 13, 2004 by Dominissini, is for an overhead airbag deployment apparatus and method. The overhead airbag assembly has an airbag module designed to be attached to the roof of a vehicle, rearward of the header. The airbag module is concealed from vehicle occupants via a headliner assembly that includes a headliner, header trim, central console, and sun visors. The header trim covers at least a portion of the header and overlaps the forward edge of the headliner on the passenger's side. The passenger's side headliner is shaped to form a deployment door to permit emergence of the inflating airbag cushion. The headliner is tethered to the roof via a frangible fastener so that the headliner does not interfere with inflation or strike the occupant.

U.S. Patent Application #20030052476, published Mar. 20, 2003 by Rose, provides a thin airbag module design for overhead applications. The thin compressible overhead airbag module provides inflatable overhead passive restraint protection to out of position occupants within a vehicle. The flat module design is compressed following assembly, making the compressed module thin enough to be mounted in the overhead space between the vehicle roof skin and the interior headliner. The general design includes an inflator, an inflatable cushion, and a 2-piece compressible housing. The compressible housing provides substantially more packaging space for the cushion. The roof area design allows the use of a longer, small diameter inflator. Upon activation, the car forward location of the inflator relative to the inflatable cushion forces the housing to deform below the inflator. The inflation force generated by the inflator effectively pulls the inflatable cushion out of the airbag module.

U.S. Pat. No. 6,116,644, issued Sep. 12, 2000 to Viano, indicates a frontal air bag system for a vehicle including an inflator mounted to vehicle structure and a frontal air bag operatively connected to the inflator and mounted to an A-pillar and header of the vehicle. The frontal air bag system also includes a wrap air bag at least partially continuous with the frontal air bag. The frontal air bag and the wrap air bag are mounted to an A-pillar of the vehicle. The frontal air bag and the wrap air bag are inflated by the inflator and the frontal air bag is extended downward and in front of an occupant seated in the vehicle and the wrap air bag is extended above the frontal air bag.

U.S. Pat. No. 6,588,793, issued Jul. 8, 2003 to Rose, puts forth a thin compressible overhead airbag module, which provides inflatable overhead passive restraint protection to out of position occupants within a vehicle. The flat module design is compressed following assembly, making the compressed module thin enough to be mounted in the overhead space between the vehicle roof skin and the interior headliner. The general design includes an inflator, an inflatable cushion, and a 2-piece compressible housing. The compressible housing provides substantially more packaging space for the cushion. The roof area design allows the use of a longer, small diameter inflator. Upon activation, the car forward location of the inflator relative to the inflatable cushion forces the housing to deform below the inflator. The inflation force generated by the inflator effectively pulls the inflatable cushion out of the airbag module.

U.S. Pat. No. 6,705,636, issued Mar. 16, 2004 to Takahara, concerns a head protection airbag system for a vehicle with a roof side rail, which includes an airbag stored in the vehicle along the roof side rail, and an inflator mounted to the roof side rail. The inflator is operable to supply a gas that inflates the airbag so that the airbag deploys into a curtain-like shape along a sidewall of a passenger compartment. A bracket, which is formed of an energy absorbing material, is interposed between the roof side rail and the inflator for mounting the inflator to the roof side rail such that the inflator is movable over a predetermined distance, whereby an external force applied to the inflator is mitigated by the bracket.

U.S. Pat. No. 5,470,103, issued Nov. 28, 1995 to Vaillancourt, illustrates a motor vehicle head impact air bag system. A motor vehicle is provided with an air bag system having a singular air bag that deploys downward from the ceiling to cushion the front and both sides of both the driver and a front seat passenger from over their head and to at least their shoulders to prevent their impacting with upper interior portions of the vehicle and with each other in a collision. The air bag includes an elongated front section that extends transverse of the vehicle along the front of the seats, elongated side sections that extend rearwardly from the front section along the outer side of the respective seats, and an elongated intermediate section that extends rearwardly from the front section between the seats.

U.S. Pat. No. 6,312,008, issued Nov. 6, 2001 to Neag, describes an air bag system that includes an energy absorption bracket attaching the air bag to the vehicle body. The energy absorption bracket includes a generally planar surface for attachment of the air bag module thereto. The bracket also includes at least two down standing legs that interconnect the generally planar surface and the vehicle body. By use of these down standing legs the bracket forms a space between the air bag and the vehicle body whereby if an object strikes the air bag, the bracket with deform and collapse into said space thereby, absorbing the impact energy from the object.

U.S. Pat. No. 5,845,937, issued Dec. 8, 1998 to Smith, claims a structural assembly that is useful in protecting occupants of a motor vehicle in the event of a collision. It includes a substantially closed rigid tubular metal element connected to a source of generating fluid pressure, such as a gas-generating inflator. The element is in flattened condition when installed. At the time of an imminent accident, the inflator generates fluid pressure to enlarge the flattened tubular element to increase its rigidity, strength, and resistance to buckling. What is needed in an open top or convertible vehicle is a roll bar with sensors and air bags that inflate in the event of a vehicle roll-over activated by the sensors to cover the top and the sides of the driver and passenger compartment to protect the occupants.

### SUMMARY OF THE INVENTION

An object of the present invention is to provide in an open top or convertible vehicle a roll bar with sensors and air bags that inflate in the event of a vehicle rollover activated by the sensors to cover the top and the sides of the driver and passenger compartment to protect the occupants.

Another object of the present invention is that during normal vehicle operation the airbags are stowed behind covers to protect them from tampering and provide an attractive interior facade for the convertible.

An additional object of the present invention is that it provides effective top and side airbag protection for open vehicles.

A further object of the present invention is that the rollover sensor is mounted inside the roll bar.

A contributory object of the present invention is that roll bar is adapted to be welded to each side of the vehicle.

In brief, a vehicle safety device for open top, convertible or soft-topped vehicles provides a roll bar, with an interior rollover sensor and air bags, welded to an existing vehicle on the sides. In a rollover situation, the sensor triggers a release mechanism to release and inflate the airbags to cover an entire area over a top and sides of the driver and passenger compartment of the vehicle to protect all occupants of a vehicle in a roll over situation.

An advantage of the present invention is that it provides in an open top or convertible vehicle a roll bar with sensors and air bags to protect the occupants.

Another advantage of the present invention is that during normal vehicle operation it provides an attractive interior facade for the convertible.

One more advantage of the present invention is that it provides effective top and side airbag protection for open vehicles.

Yet another advantage of the present invention is that the rollover sensor is mounted inside the roll bar.

Still another advantage of the present invention is that roll bar is adapted to be welded to each side of a vehicle.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of an open top vehicle with the roll bar of the present invention installed in the vehicle;

FIG. 2 is a perspective view of the open top vehicle with the airbags of the present invention inflated to cover the top and sides of the open top vehicle.

### BEST MODE FOR CARRYING OUT THE INVENTION

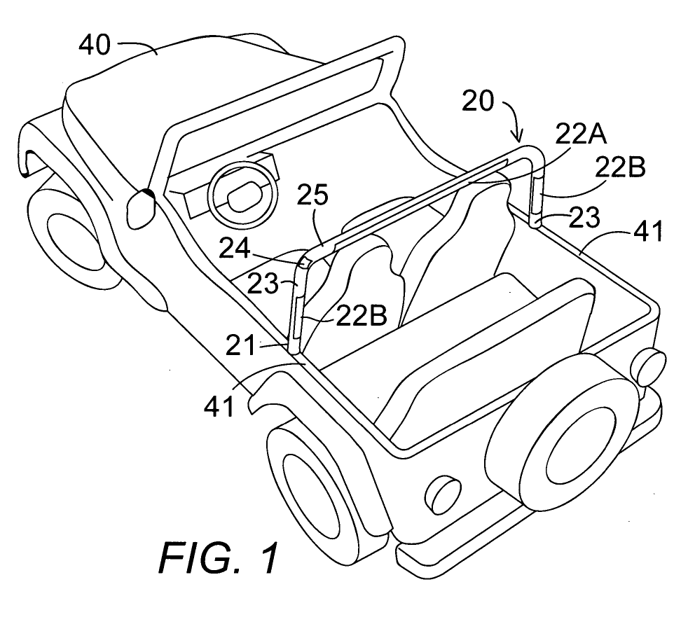

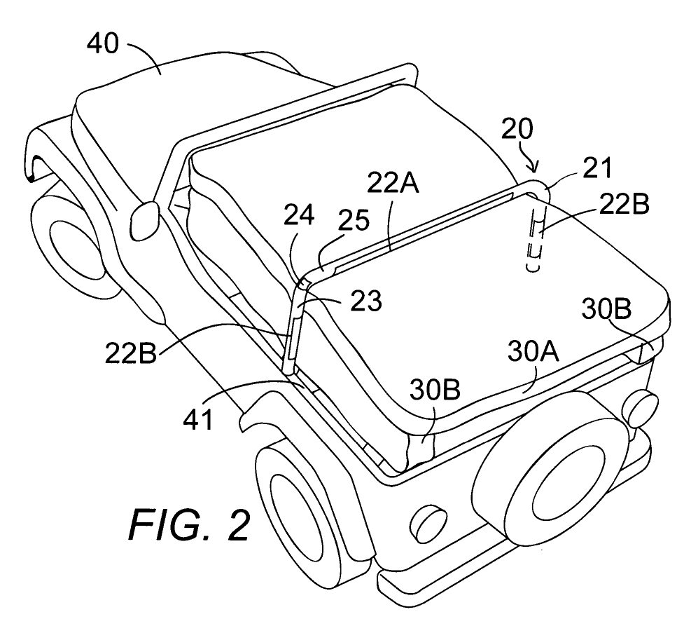

In FIGS. 1 and 2, a roll bar airbag inflation system 20 protects a driver and riders in an open top or convertible vehicle 40.

The system comprises a roll bar 21 that permanently mounts on a vehicle by welding to the sides 41 of the open vehicle 40 and consists of a rigid structural member that extends over the occupants between two sides 41 of a vehicle 40. The top bar portion 25 of the roll bar rests above the head level of the occupants of a vehicle and has a pair of side bar portions 23 extending downwardly from the top bar at each of the two ends of the top bar between the top bar and a vehicle to which the roll bar is mountable. A top airbag 30 A is mounted inside a cover 22A on the top bar. In a rollover situation, the top airbag 30A is released by a top release mechanism from the top bar and is adapted to inflate by an inflation mechanism, similar to conventional airbag release and inflation mechanisms, to cover a top area above a driver and a passenger area of a vehicle (as seen in FIG. 2) in a vehicle roll over situation to protect all occupants of a vehicle.

A side air bag 30 B mounts inside each of the side bars 23 under covers 22B with the side airbags adapted to be released by side release mechanisms from the sidebar 23 and adapted to inflate by an inflation mechanism, similar to conventional airbag release and inflation mechanisms, to cover an entire side area of a driver and passenger area of a vehicle in a vehicle roll over situation to protect all occupants of a vehicle.

A roll over sensor 24 that is mounted inside the roll bar 21 communicates with the release mechanisms of the airbags 30A and 30B so that upon sensing a vehicle rollover situation the rollover sensor activates the release mechanisms to release and inflate the airbags.

The roll bar 21 comprises a hollow portion for each of the airbags under a top cover 22A for the top airbag and side cover 22 B for each of the of the side air bags. The covers are adapted to open by conventional release mechanisms upon a signal from the rollover sensor-24 to allow the air bag to escape from the hollow portion.

The roll bar 21 is preferably an inverted square U-shaped bar that is adapted to be welded to each side of a vehicle and is preferably fabricated of structural steel.

In use, when the sensor 24 detects that the vehicle is rolling over, it triggers the release mechanisms to open the covers and release and inflate the airbags 30A and 30B to cover the open top and sides above and around the people in the vehicle to protect them, as shown in FIG. 2.

It is understood that the preceding description is given merely by way of illustration and not in limitation of the invention and that various modifications may be made thereto without departing from the spirit of the invention as claimed.

What is claimed is:

1. A roll bar airbag inflation system to protect a driver and riders in open top and convertible vehicles, the system comprising:
a roll bar permanently mountable on a vehicle, the roll bar comprising a rigid structural member adapted to extend between two sides of a vehicle with a top bar portion of the roll bar above a head level of occupants of a vehicle and a pair of side bar portions extending downwardly from the top bar at each of two ends of the top bar between the top bar and a vehicle to which the roll bar is mountable, a top airbag mounted inside the top bar, the top airbag adapted to be released by a top release mechanism from the top bar and adapted to inflate by an inflation mechanism to cover a top area above a driver and passenger area of a vehicle in a vehicle roll over situation to protect all occupants of a vehicle and a side air bag mounted inside each of the side bars, the side airbag adapted to be released by a side release mechanism from the side bar and adapted to inflate by an inflation mechanism to cover an entire side area of a driver and passenger area of a vehicle in a vehicle roll over situation to protect all occupants of a vehicle, a rollover sensor communicating with the release mechanisms of the airbags, so that upon sensing a vehicle rollover situation, the rollover sensor activates the release mechanisms to release and inflate the airbags.

2. The system of claim 1 wherein the rollover sensor is mounted inside the roll bar.

3. The system of claim 1 wherein the roll bar further comprises a hollow portion for each of the airbags, the hollow portion adapted to receive the airbag therein and a cover over the hollow portion, the cover adapted to be opened by the release mechanism upon a signal from the rollover sensor to allow the airbag to escape from the hollow portion.

4. The system of claim 1 wherein the roll bar is an inverted square U shaped bar adapted to be welded to each side of a vehicle.

5. The system of claim 1 wherein the roll bar is fabricated of structural steel.
